(19) United States
(12) Patent Application Publication
(10) Pub. No.: US 2014/0141203 A1
(43) Pub. Date: May 22, 2014

(54) NONWOVEN SANITARY TISSUE PRODUCTS COMPRISING A WOVEN SURFACE PATTERN

(71) Applicant: THE PROCTER & GAMBLE COMPANY, CINCINNATI, OH (US)

(72) Inventors: Emma Lynn SARTINI, Cincinnati, OH (US); Andre MELLIN, Amberley Village, OH (US)

(73) Assignee: THE PROCTER & GAMBLE COMPANY, CINCINNATI, OH (US)

(21) Appl. No.: 14/084,717

(22) Filed: Nov. 20, 2013

Related U.S. Application Data
(60) Provisional application No. 61/728,326, filed on Nov. 20, 2012.

(51) Int. Cl. D21H 27/00; D21H 27/02; B31F 1/07

(52) U.S. Cl. CPC D21H 27/002; B31F 1/07; D21H 27/02
USPC 428/156; 264/293; 162/202

(57) ABSTRACT

Nonwoven sanitary tissue products having a woven surface pattern that provides the nonwoven sanitary tissue product with a woven appearance and a method for making such sanitary tissue products are provided.

### FIELD OF THE INVENTION

The present invention relates to nonwoven sanitary tissue products and more particularly to paper sanitary tissue products comprising a woven surface pattern and a method for making such sanitary tissue products.

### BACKGROUND OF THE INVENTION

Consumers of nonwoven sanitary tissue products, particularly paper sanitary tissue products such as bath tissue, facial tissue, and paper towels desire paper products that appear and/or perform closer to woven fabrics, such as wash cloths, hand towels, and the like. When a paper sanitary tissue product looks more like a woven cloth or fabric, the consumers perceive the paper sanitary tissue product as having physical properties such as softness, strength, cleaning ability, absorbency, and the like closer to those of a woven cloth and/or fabric. In general, consumers desire their paper sanitary tissue products to not look and/or perform like paper, but rather look and/or perform like a woven cloth and/or fabric.

Formulators of paper sanitary tissue products continually work to impart physical properties of softness, strength, cleaning ability, absorbency, and the like into their paper sanitary tissue products by changing the makeup of the paper products, by forming the paper products differently, by adding additives to the paper products, and by marketing the paper products differently.

In addition, some formulators have attempted to product paper sanitary tissue products that look more like woven cloths and/or fabrics by imparting surface patterns, for example embossed and/or wet-formed patterns, to the paper sanitary tissue products that attempt to give the appearance of a woven cloth and/or fabric. One of the tools formulators use is a repeating design element. Many known surface patterns on sanitary tissue products comprise repeating design elements, such as diamonds, squares, hexagons, and other geometric shapes made from dot embossments.

A known surface pattern used on paper sanitary tissue products includes repeating wavy diamond and/or square design elements made from discrete dot embossments such as is shown in FIG. 1. Such repeating design elements are not connected to one another, especially by respective termini.

As shown in FIGS. 2A and 2B, another known surface pattern uses bands formed from dots, such as dot embossments, alone or in combination with bands formed from line elements in an attempt to produce a woven appearance on a sanitary tissue product.

Another known surface pattern shown in FIG. 3 comprises a grid-like network to impart an appearance such as a net on a sanitary tissue product as shown in FIG. 3.

The known surface patterns continue to not adequately convey a woven appearance to their sanitary tissue products. Accordingly, consumers of sanitary tissue products, especially paper sanitary tissue products such as bath tissue, paper towels and/or facial tissue, continue to desire sanitary tissue products that look like woven cloths and/of fabrics, and thus desire surface patterns on their sanitary tissue products that provide a woven appearance to the sanitary tissue products.

Accordingly, there is a need for a sanitary tissue product comprising a novel surface pattern that communicates a woven product to a consumer of the sanitary tissue product and thus communicates softness, strength, clothlike, and/or improved cleaning compared to other sanitary tissue products comprising known surface patterns.

### SUMMARY OF THE INVENTION

The present invention fulfills the need described above by providing a sanitary tissue product comprising a surface pattern that communicates a woven product to a consumer of the sanitary tissue product.

In one example of the present invention, a sanitary tissue product comprising a surface pattern having a repeating design element, wherein the repeating design element comprises a first design element component having two adjacent open termini and two adjacent closed termini and a second design element component, which is generated by rotating the first design element component 180°, and wherein the first design element component of a first repeating design element is connected to the second design element component of a second repeating design element through their respective opposing open termini, is provided.

In another example of the present invention, a method for making a sanitary tissue product according to the present invention, the method comprising the step of:

a. imparting a surface pattern comprising a repeating design element, wherein the repeating design element comprises a first design element component having two adjacent open termini and two adjacent closed termini and a second design element component, which is generated by rotating the first design element component 180°, and wherein the first design element component of a first repeating design element is connected to the second design element component of a second repeating design element through their respective opposing open termini, is provided.

The present invention provides a sanitary tissue product comprising a novel surface pattern that imparts a woven appearance to the sanitary tissue product and a method for making same.

### BRIEF DESCRIPTION OF THE DRAWINGS

FIG. 1 is a top plan view of a prior art surface pattern for a sanitary tissue product;

FIG. 2A is a top plan view of another prior art surface pattern for a sanitary tissue product;

FIG. 2B is a top plan view of another prior art surface pattern for a sanitary tissue product;

FIG. 3 is a top plan view of another prior art surface pattern for a sanitary tissue product;

FIG. 4 is a schematic representation of an example of a design element according to the present invention;

FIG. 5 is a schematic representation of an example of a repeating design element according to the present invention;

FIG. 6 is a schematic representation of an example of a surface pattern comprising a repeating design element of FIG. 5 according to the present invention;

FIG. 7 is a schematic representation of an example of a comparative surface pattern;

FIG. 8 is a schematic representation of an example of another comparative surface pattern;

FIG. 9 is a schematic representation of an example of another comparative surface pattern;

FIG. 10 is a schematic representation of an example of another comparative surface pattern;

FIG. 11 is a schematic representation of an example of another comparative surface pattern;

FIG. 12 is a schematic representation of an example of another comparative surface pattern;

FIG. 13 is a schematic representation of an example of a sanitary tissue product having a surface pattern according to the present invention;

FIG. 14 is a schematic representation of another example of a sanitary tissue product having a surface pattern according to the present invention;

FIG. 15 is a schematic representation of another example of a sanitary tissue product having a surface pattern according to the present invention;

FIG. 16 is a schematic representation of another example of a sanitary tissue product having a surface pattern according to the present invention;

FIG. 17 is a schematic representation of another example of a sanitary tissue product having a surface pattern according to the present invention;

FIG. 18 is a photograph of an example of a sanitary tissue product having a surface pattern, background design element, and a micro-pattern according to the present invention; and

FIG. 19 is a photograph of another example of a sanitary tissue product having a surface pattern, background design element, and a micro-pattern according to the present invention.

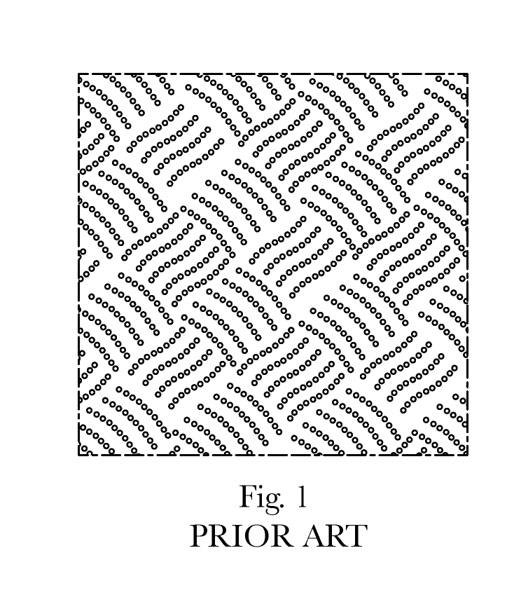

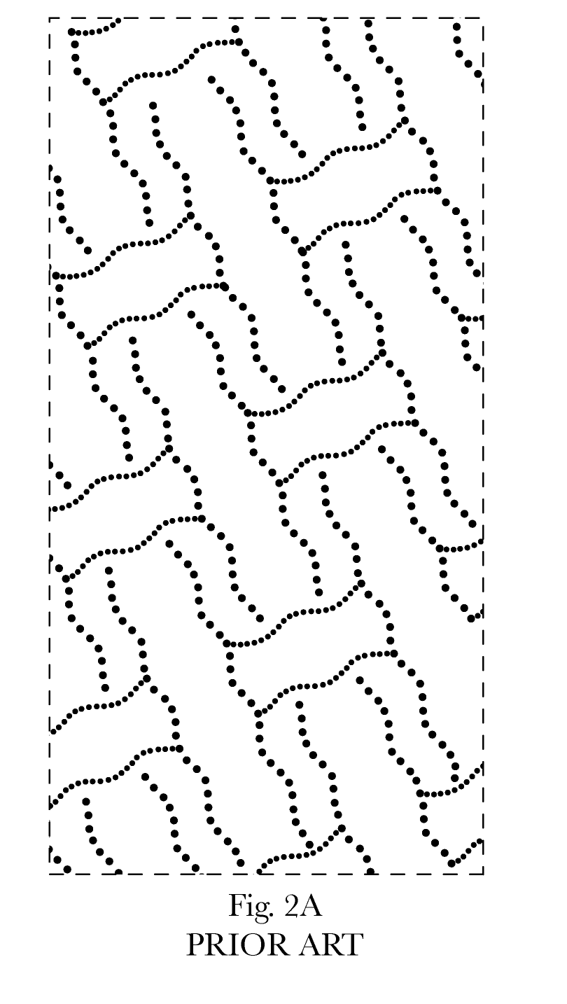

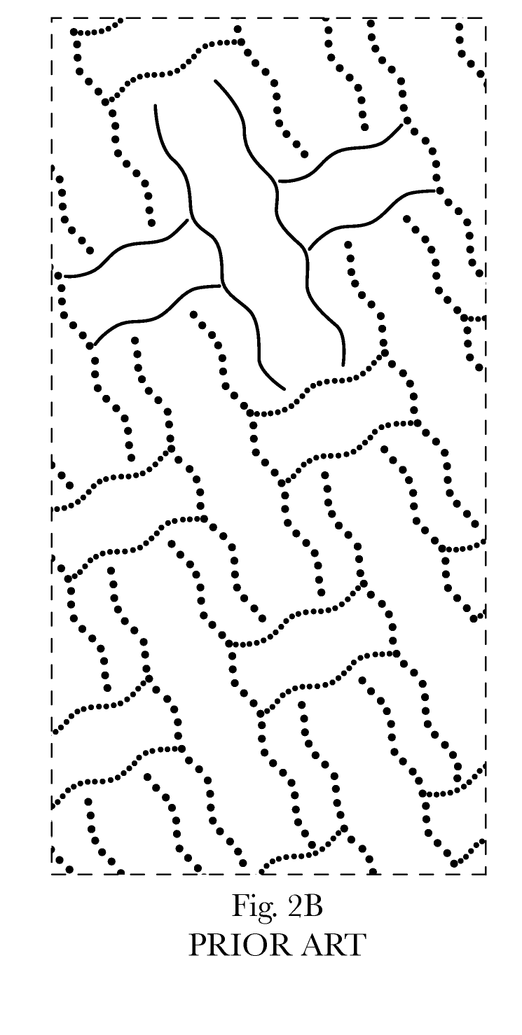

### DETAILED DESCRIPTION OF THE INVENTION

### Definitions

“Sanitary tissue product” as used herein means a soft, low density (i.e. <about 0.15 g/cm³ measured at 95 g/in²) sanitary tissue product useful as a wiping implement for post-urinary and post-bowel movement cleaning (toilet tissue), for otorhinolaryngological discharges (facial tissue), multi-functional absorbent and cleaning uses (absorbent towels) and wet and dry wipes. The sanitary tissue product may be convolutedly wound upon itself about a core or without a core to form a sanitary tissue product roll. Alternatively, the sanitary tissue product may be in the form of discrete sheets. The sanitary tissue product may be a through-air-dried sanitary tissue product, a wet-pressed sanitary tissue product, a belt-creped sanitary tissue product, a fabric-creped sanitary tissue product, a creped sanitary tissue product, or an uncreped sanitary tissue product. In one example, the sanitary tissue product may comprise two or more different plies of a fibrous structure that are made by different processes, for example a through-air-dried fibrous structure ply and a belt-creped fibrous structure ply.

The sanitary tissue products and/or fibrous structures of the present invention may exhibit a basis weight of greater than 15 g/m² to about 120 g/m² and/or from about 15 g/m² to about 110 g/m² and/or from about 20 g/m² to about 100 g/m² and/or from about 30 g/m² to 90 g/m². In addition, the sanitary tissue products and/or fibrous structures of the present invention may exhibit a basis weight between about 40 g/m² to about 120 g/m² and/or from about 50 g/m² to about 110 g/m² and/or from about 55 g/m² to about 105 g/m² and/or from about 60 g/m² to 100 g/m².

The sanitary tissue products of the present invention may exhibit a density (measured at 95 g/in²) of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets.

The sanitary tissue products of the present invention may comprise additives such as softening agents such as silicones and quaternary ammonium compounds, temporary wet strength agents, permanent wet strength agents, bulk softening agents, lotions, silicones, wetting agents, latexes, especially surface-pattern-applied latexes, dry strength agents such as carboxymethylcellulose and starch, and other types of additives suitable for inclusion in and/or on sanitary tissue products.

“Fibrous structure” as used herein means a structure that comprises one or more filaments and/or fibers. In one example, a fibrous structure according to the present invention means an orderly arrangement of filaments and/or fibers within a structure in order to perform a function. Non-limiting examples of fibrous structures of the present invention include paper, fabrics (including woven, knitted, and non-woven), and absorbent pads (for example for diapers or feminine hygiene products).

Non-limiting examples of processes for making fibrous structures include known wet-laid papermaking processes, which includes rush transfer and/or fabric creping and/or wet-micro contraction and/or wet pressing papermaking processes and air-laid papermaking processes. Such processes typically include steps of preparing a fiber composition in the form of a suspension in a medium, either wet, more specifically aqueous medium, or dry, more specifically gaseous, i.e. with air as medium. The aqueous medium used for wet-laid processes is oftentimes referred to as a fiber slurry. The fibrous slurry is then used to deposit a plurality of fibers onto a forming wire or belt such that an embryonic fibrous structure is formed, after which drying and/or bonding the fibers together results in a fibrous structure. Further processing the fibrous structure may be carried out such that a finished fibrous structure is formed. For example, in typical papermaking processes, the finished fibrous structure is the fibrous structure that is wound on the reel at the end of papermaking, and may subsequently be converted into a finished product, e.g. a sanitary tissue product.

The fibrous structures of the present invention may be homogeneous or may be layered. If layered, the fibrous structures may comprise at least two and/or at least three and/or at least four and/or at least five layers.

The fibrous structures of the present invention may be co-formed fibrous structures. “Co-formed fibrous structure” as used herein means that the fibrous structure comprises a mixture of at least two different materials wherein at least one of the materials comprises a filament, such as a polypropylene filament, and at least one other material, different from the first material, comprises a solid additive, such as a fiber and/or a particulate. In one example, a co-formed fibrous structure comprises solid additives, such as fibers, such as wood pulp fibers, and filaments, such as polypropylene filaments.

“Solid additive” as used herein means a fiber and/or a particulate.

“Particulate” as used herein means a granular substance or powder.

“Fiber” and/or “Filament” as used herein means an elongate particulate having an apparent length greatly exceeding its apparent width, i.e. a length to diameter ratio of at least about 10. In one example, a “fiber” is an elongate particulate as described above that exhibits a length of less than 5.08 cm (2 in.) and a “filament” is an elongate particulate as described above that exhibits a length of greater than or equal to 5.08 cm (2 in.).

Fibers are typically considered discontinuous in nature. Non-limiting examples of fibers include wood pulp fibers and synthetic staple fibers such as polyester fibers.

Filaments are typically considered continuous or substantially continuous in nature. Filaments are relatively longer than fibers. Non-limiting examples of filaments include meltblown and/or spunbond filaments. Non-limiting examples of materials that can be spun into filaments include hydroxyl polymers, for example natural polymers, such as starch, starch derivatives, cellulose and cellulose derivatives, hemicellulose, hemicellulose derivatives, and synthetic hydroxyl polymers including, but not limited to polyvinyl alcohol filaments and/or polyvinyl alcohol derivative filaments, and thermoplastic polymer filaments, such as polyesters, nylons, polyolefins such as polypropylene filaments, polyethylene filaments, and biodegradable or compostable thermoplastic fibers such as polylactic acid filaments, polyhydroxyalkanoate filaments and polycaprolactone filaments. The filaments may be monocomponent or multicomponent, such as bicomponent filaments.

In one example of the present invention, “fiber” refers to papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. U.S. Pat. No. 4,300,981 and U.S. Pat. No. 3,994,771 are incorporated herein by reference for the purpose of disclosing layering of hardwood and softwood fibers. Also applicable to the present invention are fibers derived from recycled paper, which may contain any or all of the above categories as well as other non-fibrous materials such as fillers and adhesives used to facilitate the original papermaking Non-limiting examples of suitable hardwood pulp fibers include eucalyptus and acacia. Non-limiting examples of suitable softwood pulp fibers include Southern Softwood Kraft (SSK) and Northern Softwood Kraft (NSK).

In addition to the various wood pulp fibers, other cellulosic fibers such as cotton linters, rayon, lyocell, bamboo, and bagasse can be used in this invention. Other sources of cellulose in the form of fibers or capable of being spun into fibers include grasses and grain sources.

In addition, trichomes such as from “lamb's ear” plants and seed hairs can also be utilized in the fibrous structures of the present invention.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121.

“Basis Weight” as used herein is the weight per unit area of a sample reported in lbs/3000 ft² or g/m² and is measured according to the Basis Weight Test Method described herein.

“Caliper” as used herein means the macroscopic thickness of a fibrous structure. Caliper is measured according to the Caliper Test Method described herein.

“Bulk” as used herein is calculated as the quotient of the Caliper, expressed in microns, divided by the Basis Weight, expressed in grams per square meter. The resulting Bulk is expressed as cubic centimeters per gram. For the products of this invention, Bulks can be greater than about 3 cm³/g and/or greater than about 6 cm³/g and/or greater than about 9 cm³/g and/or greater than about 10.5 cm³/g up to about 30 cm³/g and/or up to about 20 cm³/g . The products of this invention derive the Bulks referred to above from the basesheet, which is the sheet produced by the tissue machine without post treatments such as embossing. Nevertheless, the basesheets of this invention can be embossed to produce even greater bulk or aesthetics, if desired, or they can remain unembossed. In addition, the basesheets of this invention can be calendered to improve smoothness or decrease the Bulk if desired or necessary to meet existing product specifications.

“Density” as used herein is calculated as the quotient of the Basis Weight expressed in grams per square meter divided by the Caliper expressed in microns.

“Machine Direction” or “MD” as used herein means the direction parallel to the flow of the fibrous structure through the fibrous structure making machine and/or sanitary tissue product manufacturing equipment.

“Cross Machine Direction” or “CD” as used herein means the direction parallel to the width of the fibrous structure making machine and/or sanitary tissue product manufacturing equipment and perpendicular to the machine direction.

“Ply” as used herein means an individual, integral fibrous structure.

“Plies” as used herein means two or more individual, integral fibrous structures disposed in a substantially contiguous, face-to-face relationship with one another, forming a multi-ply sanitary tissue product. It is also contemplated that an individual, integral fibrous structure can effectively form a multi-ply sanitary tissue product, for example, by being folded on itself.

“Surface pattern” with respect to a nonwoven sanitary tissue product, especially a paper sanitary tissue product in accordance with the present invention means herein a pattern that is present on at least one surface of the sanitary tissue product. The surface pattern may be a textured surface pattern such that the surface of the sanitary tissue product comprises protrusions and/or depressions as part of the surface pattern. For example, the surface pattern may comprise embossments and/or wet-formed texture. The surface pattern may be a non-textured surface pattern such that the surface of the sanitary tissue product does not comprise protrusions and/or depressions as part of the surface pattern. For example, the surface pattern may be printed on a surface of the sanitary tissue product.

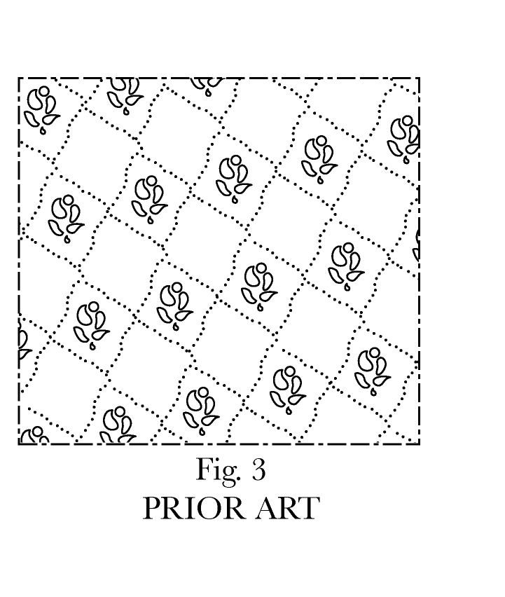

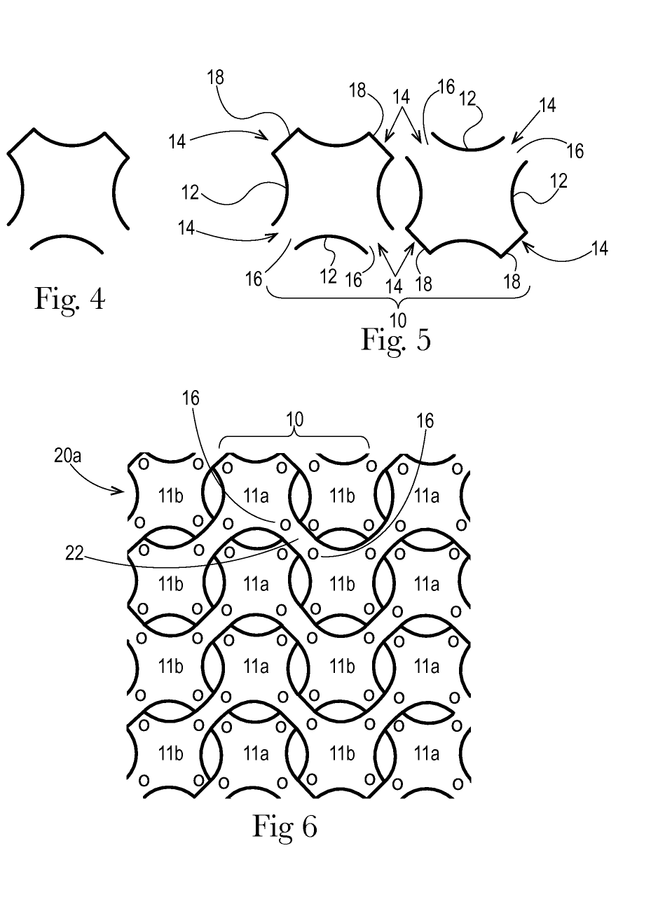

“Design element” as used herein means a discrete, object present on a surface of a sanitary tissue product. Non-limiting examples of design elements include representations of flowers, butterflies, animals, and geometric shapes. In one example, the design element is a shape that is formed by one or more line elements. In another example, the design element is formed by two line elements as shown in FIG. 4. In one example, the design element may be an embossed design element. In another example, the design element may be a wet-formed design element. In still another example, the design element may have a portion that is embossed and another portion that is wet-formed.

“Repeating design element” as used herein with respect to a surface pattern means a design element that repeats two or more, and/or a plurality of times within the surface pattern. In one example, as shown in FIG. 5, the repeating design element comprises a first design element component, which itself is a design element such as FIG. 4, and a second design element component, which itself is a design element such as FIG. 4, but generated by rotating the first design element component 180°, that when combined form the repeating design element. In one example, two or more and/or greater than 15% and/or greater than 25% and/or greater than 50% and/or greater than 75% and/or 100% of the repeating design elements are connected to at least one other adjacent design element within the surface pattern. In one example, the plurality of repeating design elements covers greater than 5% and/or greater than 10% and/or greater than 20% and/or greater than 30% and/or greater than 40% and/or greater than 50% and/or greater than 60% and/or greater than 70% and/or to about 100% and/or to about 90% and/or to about 80% of the surface area of the sanitary tissue product.

“Embossed” as used herein with respect to a sanitary tissue product means a sanitary tissue product that has been subjected to a process which converts a smooth surfaced fibrous structure to a decorative surface by replicating a design on one or more emboss rolls, which form a nip through which the fibrous structure passes. Embossed does not include creping, microcreping, printing or other processes that may impart a texture and/or decorative pattern to a fibrous structure.

“Line element” as used herein means a continuous line that has an aspect ratio of greater than 1.5:1 and/or greater than 1.75:1 and/or greater than 2:1 and/or greater than 5:1. In one example, the line element exhibits a length of at least 2 mm and/or at least 4 mm and/or at least 6 mm and/or at least 1 cm to about 10.16 cm and/or to about 8 cm and/or to about 6 cm and/or to about 4 cm.

The continuous lines and/or broken lines of the filamentary pattern and/or filamentary line pattern of the present invention may be formed by a line embossment or line embossments. In one example, the continuous lines and/or broken lines of the filamentary pattern and/or filamentary line pattern of the present invention may be formed by lines that are formed by wet molding and/or a through-air-drying fabric and/or an imprinted through-air-drying fabric.

“Dot element” as used herein means a dot that exhibits an aspect ratio of about 1:1. Non-limiting examples of dot elements are embossments that are shaped like circles, squares, rectangles (dashes) and/or triangles. In one example, the one or more repeating design elements may comprise one or more dots.

“Water-resistant” as it refers to a surface pattern or part thereof means that a pattern retains its structure and/or integrity after being saturated by water and the pattern is still visible to a consumer. In one example, the continuous lines and/or broken lines of the filamentary pattern and/or filamentary line pattern may be water-resistant.

### Repeating Design Element

In one example, the repeating design element 10 of the present invention comprises a geometric shape as shown in FIG. 5. The geometric shape is created by two design element components, a first design element component 11a and a second design element component 11b. Since the second design element component 11b is generated by rotating the first design element component 180°, the discussion with respect to the first design element component 11a is also applicable to the second design element component 11b. The first design element component 11a comprises two or more line elements 12 which are associated with one another to define a geometric shape. Four termini 14 exist in the first design element component 11a; two adjacent open termini 16 and two adjacent closed termini 18. The resulting repeating design element 10 (the first and second design element components 11a and 11b combined) comprises eight termini 14 comprising four total open termini 16 and four total closed termini 18.

### Surface Pattern

The surface pattern of the present invention comprises two or more and/or a plurality of repeating design elements.

In one example, the surface pattern 20a comprises a plurality of repeating design elements 10 as shown in FIG. 6. As shown in FIG. 6, two or more repeating design elements 10 are connected to each other through an opposing open termini 16 as represented by the letter “O” of a first design element component 11a of a first repeating design element 10 and an opposing open termini 16 as represented by the letter “O” of a second design element component of another (a second) repeating design element 10. The connected opposing open termini 16 form a channel 22. This channel 22 is sandwiched between two opposing closed termini 18 as represented by the letter “C” from the first design element component 11a of the second repeating design element 10 and the second design element component 11b of the first repeating design element 10. This arrangement of the connected opposing open termini 16 of two design element components from different repeating design elements 10 being sandwiched between opposing closed termini 18 of two design element components from the different repeating design elements 10 gives the appearance of a woven surface pattern and/or woven cloth and/or fabric.

In one example, the opposing closed termini 18 that sandwich the channel 22 formed between respective opposing open termini 16 share at least a portion of a common line element with the channel 22 such that the line element that forms at least part of the channel 22 also defines part of the closed termini 18.

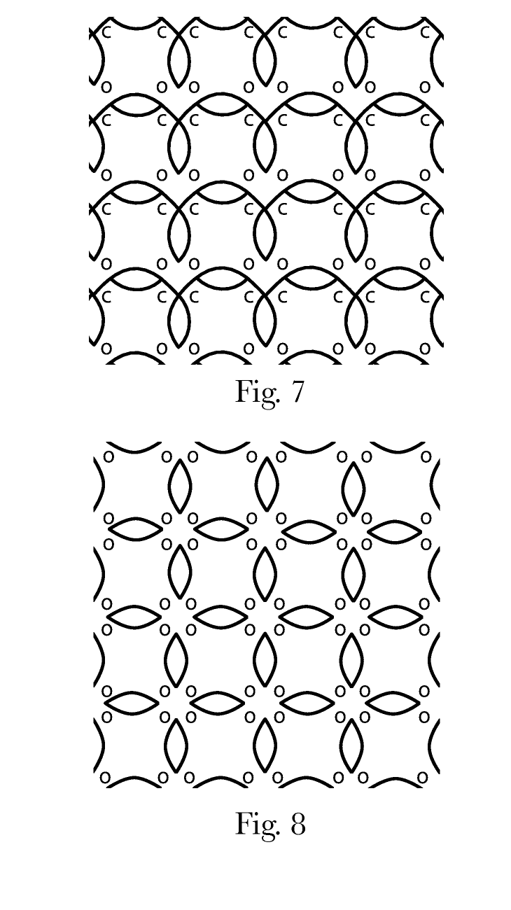

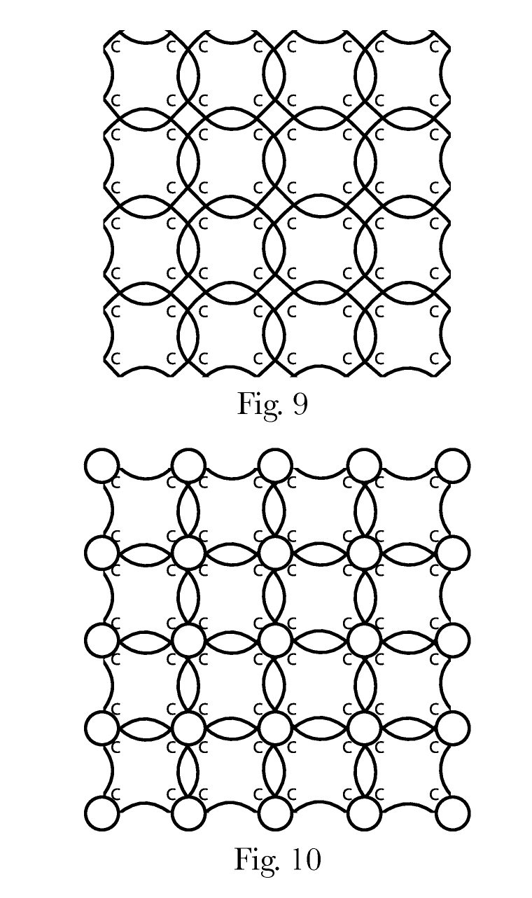

As is evident from comparative surface patterns shown in FIGS. 7-12, which lack the arrangement of the connected opposing open termini of repeating design elements being sandwiched between opposing closed termini of repeating design elements of the present invention, a woven appearance is not achieved by the arrangements of the open and closed termini as represented by the letters “O” and “C”, respectively, of their repeating design elements.

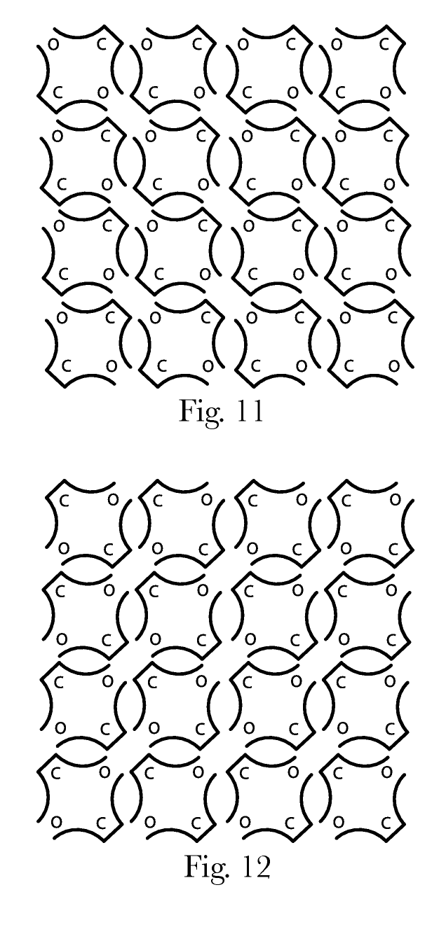

Further, as is evident from comparative surface patterns shown in FIGS. 11 and 12, which lack the arrangement of the connected opposing open termini of repeating design elements being sandwiched between opposing closed termini of repeating design elements of the present invention since the opposing open termini are not connected to one another in the surface pattern, a woven appearance is not achieved by the arrangements of the open and closed termini as represented by the letters “O” and “C”, respectively, of their repeating design elements.

### Sanitary Tissue Product

As shown in FIG. 13, an example of a sanitary tissue product 30 of the present invention comprises a surface 32 exhibiting a machine direction and a cross machine direction. The surface 32 having a surface pattern 20 comprising a repeating design element 10 comprising a first design element component 11a and a second design element component 11b. The repeating design elements 10 are connected to each other through an opposing open termini 16 of a first design element component 11a of a first repeating design element 10 and an opposing open termini 16 of a second design element component of another (a second) repeating design element 10. The connected opposing open termini 16 form a channel 22. This channel 22 is sandwiched between two opposing closed termini 18 from the first design element component 11a of the second repeating design element 10 and the second design element component 11b of the first repeating design element 10. This arrangement of the connected opposing open termini 16 of two design element components from different repeating design elements 10 being sandwiched between opposing closed termini 18 of two design element components from the different repeating design elements 10 gives the appearance of a woven surface pattern and/or woven cloth and/or fabric.

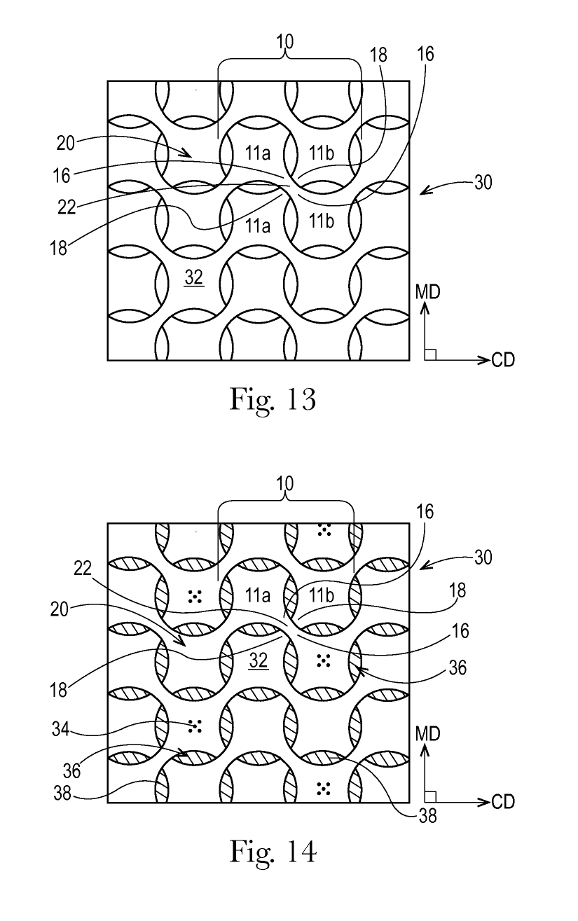

FIG. 14 illustrates another example of a sanitary tissue product 30 comprising a surface 32 exhibiting a machine direction and a cross machine direction. The surface 32 having a surface pattern 20 comprising a repeating design element 10 comprising a first design element component 11a and a second design element component 11b. The repeating design elements 10 are connected to each other through an opposing open termini 16 of a first design element component 11a of a first repeating design element 10 and an opposing open termini 16 of a second design element component of another (a second) repeating design element 10. The connected opposing open termini 16 form a channel 22. This channel 22 is sandwiched between two opposing closed termini 18 from the first design element component 11a of the second repeating design element 10 and the second design element component 11b of the first repeating design element 10. This arrangement of the connected opposing open termini 16 of two design element components from different repeating design elements 10 being sandwiched between opposing closed termini 18 of two design element components from the different repeating design elements 10 gives the appearance of a woven surface pattern and/or woven cloth and/or fabric.

As shown in FIG. 14, one or more of the repeating design elements, such as one or both of the first and second design element components 11a, 11b may comprise dot elements 34, such as dot embossments.

The surface pattern 20, as shown in FIG. 14, may further comprise another design element, such as a background design element 36, for example line elements 38 that are positioned between one or more adjacent repeating design elements 10 and/or first and/or second design element components 11a, 11b.

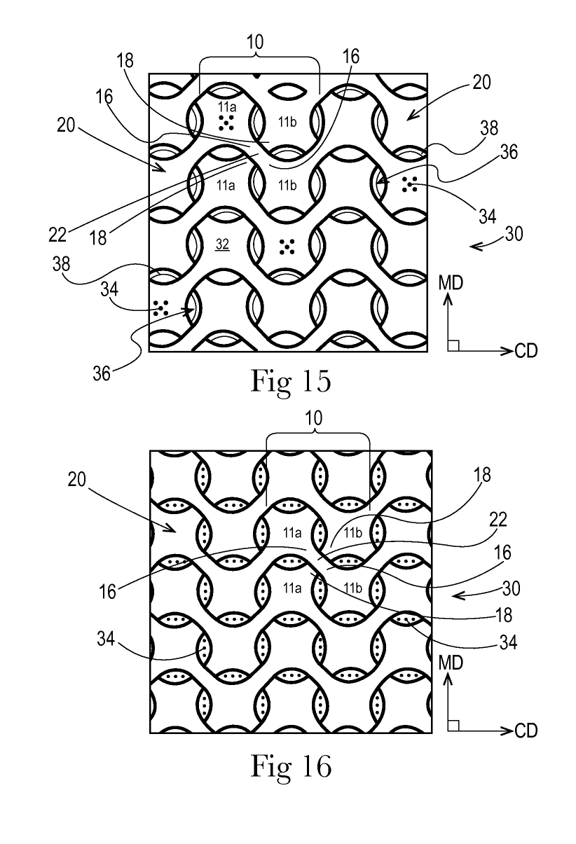

FIG. 15 illustrates another example of a sanitary tissue product 30 comprising a surface 32 exhibiting a machine direction and a cross machine direction. The surface 32 having a surface pattern 20 comprising a repeating design element 10 comprising a first design element component 11a and a second design element component 11b. The repeating design elements 10 are connected to each other through an opposing open termini 16 of a first design element component 11a of a first repeating design element 10 and an opposing open termini 16 of a second design element component of another (a second) repeating design element 10. The connected opposing open termini 16 form a channel 22. This channel 22 is sandwiched between two opposing closed termini 18 from the first design element component 11a of the second repeating design element 10 and the second design element component 11b of the first repeating design element 10. This arrangement of the connected opposing open termini 16 of two design element components from different repeating design elements 10 being sandwiched between opposing closed termini 18 of two design element components from the different repeating design elements 10 gives the appearance of a woven surface pattern and/or woven cloth and/or fabric.

As shown in FIG. 15, one or more of the repeating design elements, such as one or both of the first and second design element components 11a, 11b may comprise dot elements 34, such as dot embossments.

The surface pattern 20, as shown in FIG. 15, may further comprise another design element, such as a background design element 36, for example line elements 38 that are positioned between one or more adjacent repeating design elements 10 and/or first and/or second design element components 11a, 11b.

FIG. 16 illustrates another example of a sanitary tissue product 30 comprising a surface 32 exhibiting a machine direction and a cross machine direction. The surface 32 having a surface pattern 20 comprising a repeating design element 10 comprising a first design element component 11a and a second design element component 11b. The repeating design elements 10 are connected to each other through an opposing open termini 16 of a first design element component 11a of a first repeating design element 10 and an opposing open termini 16 of a second design element component of another (a second) repeating design element 10. The connected opposing open termini 16 form a channel 22. This channel 22 is sandwiched between two opposing closed termini 18 from the first design element component 11a of the second repeating design element 10 and the second design element component 11b of the first repeating design element 10. This arrangement of the connected opposing open termini 16 of two design element components from different repeating design elements 10 being sandwiched between opposing closed termini 18 of two design element components from the different repeating design elements 10 gives the appearance of a woven surface pattern and/or woven cloth and/or fabric.

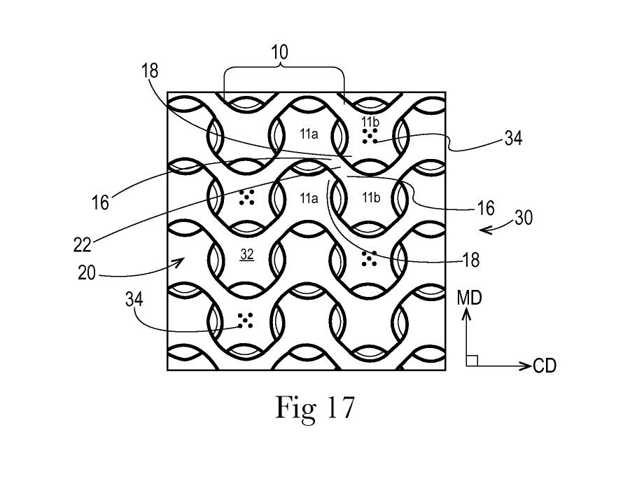

As shown in FIG. 16, the background design element 36 may comprise dot elements 34. FIG. 17 illustrates another example of a sanitary tissue product 30 comprising a surface 32 exhibiting a machine direction and a cross machine direction. The surface 32 having a surface pattern 20 comprising a repeating design element 10 comprising a first design element component 11a and a second design element component 11b. The repeating design elements 10 are connected to each other through an opposing open termini 16 of a first design element component 11a of a first repeating design element 10 and an opposing open termini 16 of a second design element component of another (a second) repeating design element 10. The connected opposing open termini 16 form a channel 22. This channel 22 is sandwiched between two opposing closed termini 18 from the first design element component 11a of the second repeating design element 10 and the second design element component 11b of the first repeating design element 10. This arrangement of the connected opposing open termini 16 of two design element components from different repeating design elements 10 being sandwiched between opposing closed termini 18 of two design element components from the different repeating design elements 10 gives the appearance of a woven surface pattern and/or woven cloth and/or fabric.

As shown in FIG. 17, one or more of the repeating design elements, such as one or both of the first and second design element components 11a, 11b may comprise dot elements 34, such as dot embossments.

As shown in FIGS. 13 and 17, the repeating design elements 10 are oriented with their surface patterns 20 such that their respective opposing closed termini 18 sandwich the channel 22 formed by their connected respective opposing open termini 16. In one example, for example as shown in FIGS. 13-17, the channel 22 is oriented at an angle with respect to the machine direction of the sanitary tissue products. In one example, the channel may be oriented at an angle of from about 10° to about 80° and/or from about 25° to about 65° and/or from about 35° to about 55°.

Further, as shown in FIGS. 14 and 15, the surface pattern may further comprise a background design element 36. The background design element 36 may comprise line elements 38. In one example, the line elements 38 may be oriented at an angle with respect to the machine direction of the sanitary tissue product of from about 10° to about 80° and/or from about 25° to about 65° and/or from about 35° to about 55°.

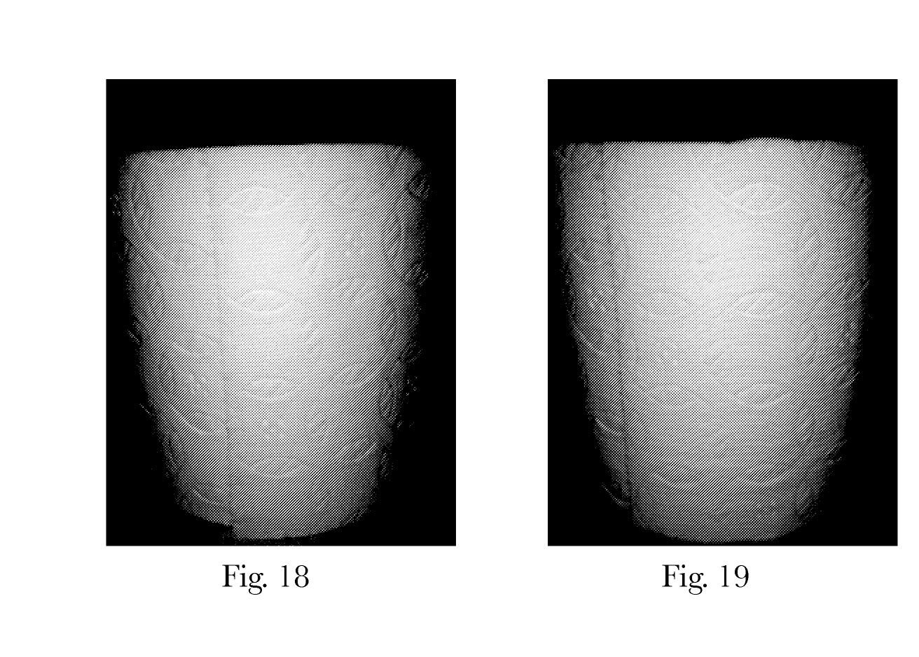

In still another example, as shown in FIGS. 18 and 19, the surface of a sanitary tissue product of the present invention may further comprise a micro-pattern, such as a wet-formed micro-pattern and/or and embossed micro-pattern and/or a thermally bonded micro-pattern, which may substantially 100% of the surface area of the surface. In one example, the micro-pattern is made up of dot elements and/or diamond elements which are a fraction of the size of the surface pattern 20. In another example, as shown in FIGS. 18 and 19, the micro-pattern comprises line elements, such as parallel line elements, for example parallel straight line elements and/or parallel sinusoidal line elements.

Any of the line elements of the present invention may have a varying width along the length of the line elements.

In one example, the background design element is wet-formed. In another example, the background design element is dry-formed. In still another example, the background design element is embossed. In even another example, the background element comprises a portion that is wet-formed and a portion that is dry-formed. In yet another example, the background design element comprises a portion that is wet-formed and a portion that is embossed.

The surface pattern on the sanitary tissue products of the present invention may be an emboss pattern, imparted by passing a sanitary tissue product through an embossing nip comprising at least one patterned embossing roll patterned to impart a surface pattern according to the present invention, and/or a water-resistant pattern (i.e., wet-molded pattern), such as a patterned through-air-drying belt that is patterned to impart a surface pattern according to the present invention, and/or a rush transfer or fabric creped or wet pressed imparted surface pattern or portions thereof, which imparts texture to the sanitary tissue product typically during the sanitary tissue product-making process.

In one example, the surface of the sanitary tissue product comprises a surface pattern that is textured. For example, a surface pattern that comprises textured ribs and/or a scrubby texture for removing, helping to remove and/or dislodge and/or being perceived as removing and/or dislodging soil, such as bowel movement soil and/or other solid and/or liquid excrements from a consumer's skin, during a wiping process by a consumer using the sanitary tissue product. In another example, the surface pattern may comprise a textured region (for example a “cleaning zone”) such as textured ribs as described above and a non-textured region (for example an “absorbent zone”) for collecting, helping to collect and/or being perceived as collecting soil, such as bowel movement soil and/or other solid and/or liquid excrements from a consumer's skin, during a wiping process by a consumer using the sanitary tissue product. In another example, a portion of the non-textured region may be or may be perceived by consumers as being anchored and/or bonded to another ply of sanitary tissue product. In even another example, the surface of the sanitary tissue product of the present invention may comprise different elevations, especially with respect to the textured and non-textured regions. For example, the non-textured region may protrude from the surface of the sanitary tissue product greater than the textured region. In other words, the repeating design element of the surface pattern may protrude from the surface of the sanitary tissue product greater than any background design element(s) protrude from the surface. This elevation difference may be actual or perceived by consumers of the sanitary tissue product.

The sanitary tissue products comprising a surface pattern of the present invention may be perceived by consumers of sanitary tissue products as being able to provide better cleaning of soil, especially bowel movement soil, compared to sanitary tissue products comprising surface patterns not within the scope of the present invention.

### Methods for Making Sanitary Tissue Products

The sanitary tissue products of the present invention may be made by any suitable process known in the art. The method may be a sanitary tissue product making process that uses a cylindrical dryer such as a Yankee (a Yankee-process) or it may be a Yankeeless process as is used to make substantially uniform density and/or uncreped sanitary tissue products.

The sanitary tissue product of the present invention may be made using a molding member. A “molding member” is a structural element that can be used as a support for an embryonic web comprising a plurality of cellulosic fibers and a plurality of synthetic fibers, as well as a forming unit to form, or “mold,” a desired microscopic geometry of the sanitary tissue product of the present invention. The molding member may comprise any element that has fluid-permeable areas and the ability to impart a microscopical three-dimensional pattern to the structure being produced thereon, and includes, without limitation, single-layer and multi-layer structures comprising a stationary plate, a belt, a woven fabric (including Jacquard-type and the like woven patterns), a band, and a roll. In one example, the molding member is a deflection member. The molding member may comprise a surface pattern according to the present invention that is imparted to the sanitary tissue product during the sanitary tissue product making process.

A “reinforcing element” is a desirable (but not necessary) element in some embodiments of the molding member, serving primarily to provide or facilitate integrity, stability, and durability of the molding member comprising, for example, a resinous material. The reinforcing element can be fluid-permeable or partially fluid-permeable, may have a variety of embodiments and weave patterns, and may comprise a variety of materials, such as, for example, a plurality of interwoven yarns (including Jacquard-type and the like woven patterns), a felt, a plastic, other suitable synthetic material, or any combination thereof.

In one example of a method for making a sanitary tissue product of the present invention, the method comprises the step of contacting an embryonic fibrous web with a deflection member (molding member) such that at least one portion of the embryonic fibrous web is deflected out-of-plane of another portion of the embryonic fibrous web. The phrase “out-of-plane” as used herein means that the sanitary tissue product comprises a protuberance, such as a dome, or a cavity that extends away from the plane of the sanitary tissue product. The molding member may comprise a through-air-drying fabric comprising a resinous framework that defines deflection conduits in the design of the desired surface pattern that allow portions of the fibrous structure to deflect into the conduits thus forming the repeating design elements within the surface pattern of the sanitary tissue products of the present invention. In addition, a forming wire, such as a foraminous member, may comprise a resinous framework that defines deflection conduits in the design of the desired surface pattern that allow portions of the fibrous structure to deflect into the conduits thus forming the repeating design elements within the surface pattern of the sanitary tissue products of the present invention.

In another example of a method for making a sanitary tissue product of the present invention, the method comprises the steps of:
(a) providing a fibrous furnish comprising fibers;
(b) depositing the fibrous furnish onto a foraminous member to form an embryonic fibrous web;
(c) associating the embryonic fibrous web with a deflection member comprising a surface pattern; and
(d) drying said embryonic fibrous web such that that the surface pattern is imparted to the dried sanitary tissue product.

In another example of a method for making a sanitary tissue product of the present invention, the method comprises the steps of:
(a) providing a fibrous structure; and
(b) imparting a surface pattern to the fibrous structure to produce the sanitary tissue product.

In yet another example, a method for making a sanitary tissue product according to the present invention comprises the steps of:

a. providing at least one ply of a fibrous structure; and

b. imparting a surface pattern to the fibrous structure to produce the sanitary tissue product, wherein the surface pattern comprises a repeating design element wherein the repeating design element comprises a first design element component having two adjacent open termini and two adjacent closed termini and a second design element component, which is generated by rotating the first design element component 180°, and wherein the first design element component of a first repeating design element is connected to the second design element component of a second repeating design element through their respective opposing open termini.

In still another example of the present invention, a method for making a sanitary tissue product according to the present invention comprises the steps of:

a. depositing fibrous elements onto a patterned belt to form a fibrous structure comprising a surface pattern having a repeating design element, wherein the repeating design element comprises a first design element component having two adjacent open termini and two adjacent closed termini and a second design element component, which is generated by rotating the first design element component 180°, and wherein the first design element component of a first repeating design element is connected to the second design element component of a second repeating design element through their respective opposing open termini; and

b. removing the fibrous structure from the patterned belt to produce the sanitary tissue product.

In another example, the step of imparting a surface pattern to a sanitary tissue product comprises contacting a molding member comprising a surface pattern with a sanitary tissue product such that the pattern is imparted to the sanitary tissue product. The molding member may be a patterned belt that comprises a surface pattern.

In another example, the step of imparting a surface pattern to a sanitary tissue product comprises passing a sanitary tissue product through an embossing nip formed by at least one embossing roll comprising a surface pattern such that the surface pattern is imparted to the sanitary tissue product.

### NON-LIMITING EXAMPLES

### Example 1

The following Example illustrates a non-limiting example for a preparation of a sanitary tissue product comprising a fibrous structure according to the present invention on a pilot-scale Fourdrinier fibrous structure making machine.

An aqueous slurry of eucalyptus (Aracruz Brazilian bleached hardwood kraft pulp) pulp fibers is prepared at about 3% fiber by weight using a conventional repulper, then transferred to the hardwood fiber stock chest. The eucalyptus fiber slurry of the hardwood stock chest is pumped through a stock pipe to a hardwood fan pump where the slurry consistency is reduced from about 3% by fiber weight to about 0.15% by fiber weight. The 0.15% eucalyptus slurry is then pumped and equally distributed in the top and bottom chambers of a multi-layered, three-chambered headbox of a Fourdrinier wet-laid papermaking machine.

Additionally, an aqueous slurry of NSK (Northern Softwood Kraft) pulp fibers is prepared at about 3% fiber by weight using a conventional repulper, then transferred to the softwood fiber stock chest. The NSK fiber slurry of the softwood stock chest is pumped through a stock pipe to be refined to a Canadian Standard Freeness (CSF) of about 630. The refined NSK fiber slurry is then directed to the NSK fan pump where the NSK slurry consistency is reduced from about 3% by fiber weight to about 0.15% by fiber weight. The 0.15% eucalyptus slurry is then directed and distributed to the center chamber of a multi-layered, three-chambered headbox of a Fourdrinier wet-laid papermaking machine.

The fibrous structure making machine has a layered headbox having a top chamber, a center chamber, and a bottom chamber where the chambers feed directly onto the forming wire. The eucalyptus fiber slurry of 0.15% consistency is directed to the top headbox chamber and bottom headbox chamber. The NSK fiber slurry is directed to the center headbox chamber. All three fiber layers are delivered simultaneously in superposed relation onto the Fourdrinier wire to form thereon a three-layer embryonic web, of which about 25% of the top side is made up of the eucalyptus fibers, about 25% is made of the eucalyptus fibers on the bottom side and about 50% is made up of the NSK fibers in the center. Dewatering occurs through the Fourdrinier wire and is assisted by a deflector and wire table vacuum boxes. The Fourdrinier wire is of an Asten Johnson 866A design. The speed of the Fourdrinier wire is about 750 feet per minute (fpm).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern of low density pillow regions and high density knuckle regions. This drying fabric is formed by casting an impervious resin surface onto a fiber mesh supporting fabric. The supporting fabric is a 127×52 filament, dual layer mesh. The thickness of the resin cast is about 12 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 56% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry-creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 750 fpm. The fibrous structure is wound in a roll using a surface driven reel drum having a surface speed of about 673 fpm. The fibrous structure may be subsequently converted into a one-ply sanitary tissue product.

The fibrous structure is then converted into a sanitary tissue product by loading the roll of fibrous structure into an unwind stand. The line speed is 800 ft/min. The fibrous structure is unwound and transported to a steam header where steam is applied to the fibrous structure at a rate of 327-383 g/min. The steam pressure is 29-38 psi and the steam temperature is 270-282° F. The fibrous structure is then transported to an emboss stand where the fibrous structure is strained to form a surface pattern according to the present invention in the fibrous structure. The embossed fibrous structure is then transported to a winder where it is wound onto a core to form a log. The log of fibrous structure is then transported to a log saw where the log is cut into finished sanitary tissue product rolls. The sanitary tissue product is soft, flexible and absorbent.

### Example 2

A sanitary tissue product in accordance with the present invention is prepared using a fibrous structure making machine having a layered headbox having a top chamber, a center chamber, and a bottom chamber. A eucalyptus fiber slurry is pumped through the top headbox chamber, a eucalyptus fiber slurry is pumped through the bottom headbox chamber (i.e. the chamber feeding directly onto the forming wire) and, finally, an NSK fiber slurry is pumped through the center headbox chamber and delivered in superposed relation onto the Fourdrinier wire to form thereon a three-layer embryonic web, of which about 33% of the top side is made up of the eucalyptus blended fibers, 33% is made of the eucalyptus fibers on the bottom side and 33% is made up of the NSK fibers in the center. Dewatering occurs through the Fourdrinier wire and is assisted by a deflector and vacuum boxes. The Fourdrinier wire is of a 5-shed, satin weave configuration having 87 machine-direction and 76 cross-machine-direction monofilaments per inch, respectively. The speed of the Fourdrinier wire is about 750 fpm (feet per minute).

The embryonic wet web is transferred from the Fourdrinier wire, at a fiber consistency of about 15% at the point of transfer, to a patterned drying fabric. The speed of the patterned drying fabric is the same as the speed of the Fourdrinier wire. The drying fabric is designed to yield a pattern of substantially machine direction oriented linear channels having a continuous network of high density (knuckle) areas. This drying fabric is formed by casting an impervious resin surface onto a fiber mesh supporting fabric. The supporting fabric is a 45×52 filament, dual layer mesh. The thickness of the resin cast is about 11 mils above the supporting fabric.

Further de-watering is accomplished by vacuum assisted drainage until the web has a fiber consistency of about 20% to 30%.

While remaining in contact with the patterned drying fabric, the web is pre-dried by air blow-through pre-dryers to a fiber consistency of about 65% by weight.

After the pre-dryers, the semi-dry web is transferred to the Yankee dryer and adhered to the surface of the Yankee dryer with a sprayed creping adhesive. The creping adhesive is an aqueous dispersion with the actives consisting of about 22% polyvinyl alcohol, about 11% CREPETROL A3025, and about 67% CREPETROL R6390. CREPETROL A3025 and CREPETROL R6390 are commercially available from Hercules Incorporated of Wilmington, Del. The creping adhesive is delivered to the Yankee surface at a rate of about 0.15% adhesive solids based on the dry weight of the web. The fiber consistency is increased to about 97% before the web is dry creped from the Yankee with a doctor blade.

The doctor blade has a bevel angle of about 25 degrees and is positioned with respect to the Yankee dryer to provide an impact angle of about 81 degrees. The Yankee dryer is operated at a temperature of about 350° F. (177° C.) and a speed of about 750 fpm. The fibrous structure is wound in a roll using a surface driven reel drum having a surface speed of about 656 feet per minute. The fibrous structure is subjected to an embossing operation that imparts a surface pattern according to the present invention to a surface of the fibrous structure. The fibrous structure may be subsequently converted into a two-ply sanitary tissue product having a basis weight of about 39 g/m². For each ply, the outer layer having the eucalyptus fiber furnish is oriented toward the outside in order to form the consumer facing surfaces of the two-ply sanitary tissue product.

The sanitary tissue product is soft, flexible and absorbent.

### Test Methods

Unless otherwise specified, all tests described herein including those described under the Definitions section and the following test methods are conducted on samples that have been conditioned in a conditioned room at a temperature of 23° C.±1.0° C. and a relative humidity of 50%±2% for a minimum of 2 hours prior to the test. All plastic and paper board packaging articles of manufacture must be carefully removed from the paper samples prior to testing. The samples tested are “usable units.” “Usable units” as used herein means sheets, flats from roll stock, pre-converted flats, and/or single or multi-ply products. Except where noted all tests are conducted in such conditioned room, all tests are conducted under the same environmental conditions and in such conditioned room. Discard any damaged product. Do not test samples that have defects such as wrinkles, tears, holes, and like. Samples conditioned as described herein are considered dry samples (such as “dry filaments”) for testing purposes. All instruments are calibrated according to manufacturer's specifications.

### Basis Weight Test Method

Basis weight of a fibrous structure is measured on stacks of twelve usable units using a top loading analytical balance with a resolution of ±0.001 g. The balance is protected from air drafts and other disturbances using a draft shield. A precision cutting die, measuring 3.500 in±0.0035 in by 3.500 in±0.0035 in is used to prepare all samples.

With a precision cutting die, cut the samples into squares. Combine the cut squares to form a stack twelve samples thick. Measure the mass of the sample stack and record the result to the nearest 0.001 g.

The Basis Weight is calculated in lbs/3000 ft² or g/m² as follows:

Basis Weight=(Mass of stack)/[(Area of 1 square in stack)×(No. of squares in stack)]

For example,

Basis Weight (lbs/3000 ft²)=[[Mass of stack (g)/453.6 (g/lbs)]/[12.25 (in²)/144 (in²/ft²)×12]]×3000

Or,

Basis Weight (g/m²)=Mass of stack (g)/[79.032 (cm²)/10,000 (cm²/m²)×12]

Report result to the nearest 0.1 lbs/3000 ft² or 0.1 g/m². Sample dimensions can be changed or varied using a similar precision cutter as mentioned above, so as at least 100 square inches of sample area in stack.

### Caliper Test Method

Caliper of a fibrous structure and/or sanitary tissue product is measured using a Progage Thickness Tester Model II (Thwing-Albert Instrument Company, West Berlin, N.J.) with a pressure foot diameter of 2.00 inches (area of 3.14 in²) at a pressure of 95 g/in². Four (4) samples are prepared by cutting of a usable unit such that each cut sample is at least 2.5 inches per side, avoiding creases, folds, and obvious defects. Create two stacks, with two samples in each, directionally aligned (i.e., MD oriented the same for both samples in the stack). The first stack is placed on the anvil with the specimen centered underneath the pressure foot. The foot is lowered at 0.03 in/sec to an applied pressure of 95 g/in². The reading is taken after 3 sec., and the foot is raised. The measure is repeated in like fashion for the remaining specimen stack. The caliper is calculated as the average caliper of the two stacks, divided by 2 (since there are 2 specimens per stack), and is reported in mils (0.001 in) to the nearest 0.1 mils.

### Elevation Test Method

An elevation of a surface pattern or portion of a surface pattern on a sanitary tissue product, for example an embossment in a sanitary tissue product can be measured using a GFM Mikrocad Optical Profiler instrument commercially available from GFMesstechnik GmbH, Warthestraβe 21, D14513 Teltow/Berlin, Germany. The GFM Mikrocad Optical Profiler instrument includes a compact optical measuring sensor based on the digital micro mirror projection, consisting of the following main components: a) DMD projector with 1024×768 direct digital controlled micro mirrors, b) CCD camera with high resolution (1300×1000 pixels), c) projection optics adapted to a measuring area of at least 44 mm×33 mm, and d) matching resolution recording optics; a table tripod based on a small hard stone plate; a cold light source; a measuring, control, and evaluation computer; measuring, control, and evaluation software ODSCAD 4.0, English version; and adjusting probes for lateral (x-y) and vertical (z) calibration.

The GFM Mikrocad Optical Profiler system measures the surface height of a sanitary tissue product sample using the digital micro-mirror pattern projection technique. The result of the analysis is a map of surface height (z) vs. xy displacement. The system has a field of view of 48×36 mm with a resolution of 29 microns. The height resolution should be set to between 0.10 and 1.00 micron. The height range is 64,000 times the resolution.

To measure the height or elevation of a surface pattern or portion of a surface pattern on a surface of a sanitary tissue product, the following can be performed: (1) Turn on the cold light source. The settings on the cold light source should be 4 and C, which should give a reading of 3000K on the display; (2) Turn on the computer, monitor and printer and open the ODSCAD 4.0 or higher Mikrocad Software; (3) Select “Measurement” icon from the Mikrocad taskbar and then click the “Live Pic” button; (4) Place a sanitary tissue product sample, of at least 5 cm by 5 cm in size, under the projection head and adjust the distance for best focus; (5) Click the “Pattern” button repeatedly to project one of several focusing patterns to aid in achieving the best focus (the software cross hair should align with the projected cross hair when optimal focus is achieved). Position the projection head to be normal to the sanitary tissue product sample surface; (6) Adjust image brightness by changing the aperture on the camera lens and/or altering the camera “gain” setting on the screen. Set the gain to the lowest practical level while maintaining optimum brightness so as to limit the amount of electronic noise. When the illumination is optimum, the red circle at bottom of the screen labeled “I.O.” will turn green; (7) Select Standard measurement type; (8) Click on the “Measure” button. This will freeze the live image on the screen and, simultaneously, the surface capture process will begin. It is important to keep the sample still during this time to avoid blurring of the captured images. The full digitized surface data set will be captured in approximately 20 seconds; (9) Save the data to a computer file with “.omc” extension. This will also save the camera image file “.kam”; (10) Export the file to the FD3 v1.0 format; 11) Measure and record at least three areas from each sample; 12) Import each file into the software package SPIP (Image Metrology, A/S, Horsholm, Denmark); 13) Using the Averaging profile tool, draw a profile line perpendicular to height or elevation (such as embossment) transition region. Expand the averaging box to include as much of the height or elevation (embossment) as practical so as to generate and average profile of the transition region (from top surface to the bottom of the surface pattern or portion of surface pattern (such as an embossment) and backup to the top surface.). In the average line profile window, select a pair of cursor points.

To move the surface data into the analysis portion of the software, click on the clipboard/man icon; (11) Now, click on the icon “Draw Lines”. Draw a line through the center of a region of features defining the texture of interest. Click on Show Sectional Line icon. In the sectional plot, click on any two points of interest, for example, a peak and the baseline, then click on vertical distance tool to measure height in microns or click on adjacent peaks and use the horizontal distance tool to determine in-plane direction spacing; and (12) for height measurements, use 3 lines, with at least 5 measurements per line, discarding the high and low values for each line, and determining the mean of the remaining 9 values. Also record the standard deviation, maximum, and minimum. For x and/or y direction measurements, determine the mean of 7 measurements. Also record the standard deviation, maximum, and minimum. Criteria that can be used to characterize and distinguish texture include, but are not limited to, occluded area (i.e. area of features), open area (area absent of features), spacing, in-plane size, and height. If the probability that the difference between the two means of texture characterization is caused by chance is less than 10%, the textures can be considered to differ from one another.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A sanitary tissue product comprising a surface pattern having a repeating design element, wherein the repeating design element comprises a first design element component having two adjacent open termini and two adjacent closed termini and a second design element component, which is generated by rotating the first design element component 180°, and wherein the first design element component of a first repeating design element is connected to the second design element component of a second repeating design element through respective opposing open termini.

2. The sanitary tissue product according to claim 1 wherein the second design element component of the first repeating design element and the first design element component of the second repeating design element are oriented such that their respective opposing closed termini sandwich the connected respective opposing open termini.

3. The sanitary tissue product according to claim 1 wherein the connected respective opposing open termini form a channel.

4. The sanitary tissue product according to claim 3 wherein the channel is oriented at an angle with respect to the machine direction of the sanitary tissue product of from about 10° to about 80°.

5. The sanitary tissue product according to claim 1 wherein the surface pattern further comprises a background pattern.

6. The sanitary tissue product according to claim 5 wherein the background pattern comprises line elements.

7. The sanitary tissue product according to claim 5 wherein the background pattern comprises dot elements.

8. The sanitary issue product according to claim 1 wherein the repeating design element comprises line elements.

9. The sanitary tissue product according to claim 8 wherein the repeating design element further comprises dot elements.

10. The sanitary tissue product according to claim 1 wherein the surface pattern is embossed.

11. The sanitary tissue product according to claim 1 wherein the sanitary tissue product comprises filaments.

12. The sanitary tissue product according to claim 11 wherein the filaments comprise a hydroxyl polymer.

13. The sanitary tissue product according to claim 1 wherein the sanitary tissue product comprises fibers.

14. The sanitary tissue product according to claim 13 wherein the fibers comprise pulp fibers.

15. The sanitary tissue product according to claim 14 wherein the pulp fibers comprise wood pulp fibers.

16. The sanitary tissue product according to claim 14 wherein the pulp fibers comprise trichomes.

17. The sanitary tissue product according to claim 1 wherein the sanitary tissue product is a through-air-dried sanitary tissue product.

18. The sanitary tissue product according to claim 1 wherein the sanitary tissue product is a wet-pressed sanitary tissue product.

19. A method for making a sanitary tissue product according to claim 1, the method comprising the steps of:
a. providing at least one ply of a fibrous structure; and
b. imparting a surface pattern to the fibrous structure to produce the sanitary tissue product, wherein the surface pattern has a repeating design element, wherein the repeating design element comprises a first design element component having two adjacent open termini and two adjacent closed termini and a second design element component, which is generated by rotating the first design element component 180°, and wherein the first design element component of a first repeating design element is connected to the second design element component of a second repeating design element through respective opposing open termini.

20. A method for making a sanitary tissue product according to claim 1, the method comprising the steps of:
a. depositing fibrous elements onto a patterned belt to form a fibrous structure comprising a surface pattern having a repeating design element, wherein the repeating design element comprises a first design element component having two adjacent open termini and two adjacent closed termini and a second design element component, which is generated by rotating the first design element component 180°, and wherein the first design element component of a first repeating design element is connected to the second design element component of a second repeating design element through respective opposing open termini; and
b. removing the fibrous structure from the patterned belt to produce the sanitary tissue product.
